(19) United States
(12) Patent Application Publication
(10) Pub. No.: US 2011/0208593 A1
(43) Pub. Date: Aug. 25, 2011

(54) ELECTRONIC ADVERTISEMENT APPARATUS, ELECTRONIC ADVERTISEMENT METHOD AND RECORDING MEDIUM

(76) Inventors: Rika Nishida, Tokyo (JP); Kazuhide Umeda, Fukuoka (JP)

(21) Appl. No.: 13/125,837

(22) PCT Filed: Nov. 10, 2009
(86) PCT No.: PCT/JP2009/069120

§ 371 Date: Apr. 25, 2011

(30) Foreign Application Priority Data
Nov. 10, 2008 (JP) 2008-288284

(51) Int. Cl. G06Q 30/00

(52) U.S. Cl. 705/14.68; 705/14.4

(57) ABSTRACT

An electronic advertisement apparatus includes: a facial image extraction device (5) that extracts a facial image, which is an image of a facial region of a viewer, from an image of the viewer captured while the viewer views an advertising image displayed on a display device (2); a feature value extraction device (6) that calculates a feature value of the appearance of the viewer by analyzing the extracted facial image; an image storage device (9) that stores a plurality of content images having key information; and a main control device (8) that compares the extracted feature value of the viewer with the stored key information in order to extract a content image having key information that corresponds to the feature value of the viewer from the image storage device (9), and displays the extracted image on the display device (2).

### TECHNICAL FIELD

The present invention relates to an electronic advertisement apparatus that is disposed in a customer attracting facility or the like in order to display advertising images.

### BACKGROUND ART

A conventional electronic advertisement apparatus is disposed in a customer attracting facility such as a theater, a cinema, or a large store in order to present moving images or still images carrying an advertising message to unspecified people visiting the customer attracting facility.

Patent Literature 1 proposes an advertising information presentation system for improving an access rate to advertisements displayed by this type of electronic advertisement apparatus. In this system, a key code is displayed on the advertisement apparatus momentarily, and when a person who was able to read the key code inputs the key code into service providing means from a terminal device such as a portable telephone, the person receives a service such as content provision from the service providing means to the terminal device.

Patent Literature 2, meanwhile, proposes an action counting system for examining the advertising effectiveness of an advertisement apparatus. In this system, first facial feature value extracting means extracts a first facial feature value by detecting a facial image of a person whose face is oriented toward the advertisement apparatus, second facial feature value extracting means extracts a second facial feature value by detecting a facial image of a person who enters a store advertised by the advertisement apparatus, the first facial feature value is compared to the second facial feature value, and a number of people having matching first and second facial feature values is counted.

### PRIOR ART DOCUMENT

### Patent Literatures

Patent Literature 1: Unexamined Japanese Patent Application KOKAI Publication No. 2004-29495
Patent Literature 2: Unexamined Japanese Patent Application KOKAI Publication No. 2008-102176

### DISCLOSURE OF INVENTION

### Problems Solved by the Invention

With the advertising information presentation system of Patent Literature 1, only those able to read the key code earn bonuses, and therefore the interest of people viewing the electronic advertisement apparatus can be aroused, leading to an improvement in advertising effectiveness. However, this effect is only exhibited when the person viewing the electronic advertisement apparatus knows the “rule” that “bonuses are earned by inputting the key code”. Therefore, to achieve this effect, the “rule” must be made known to the public using a separate advertising medium or the like. However, it takes time for the “rule” to become known. In other words, both cost and time are required for the advertising information presentation system according to Patent Literature 1 to achieve a desired effect.

Further, with the action counting system of Patent Literature 2, the advertising effectiveness of the advertisement apparatus can be examined using specific numerical values, and therefore the advertising effectiveness can be increased on the basis of the examination result by improving a disposal location of the advertisement apparatus, images displayed on the advertisement apparatus, and so on. However, a time delay occurs between examination of the advertising effectiveness and improvement of the advertising effectiveness.

The present invention has been designed in consideration of this background, and an object thereof is to provide an electronic advertisement apparatus which achieves an improvement in advertising effectiveness by actively working on a person viewing an advertisement displayed by the electronic advertisement apparatus to arouse the interest of the person.

### Means for Solving the Problem

An electronic advertisement apparatus according to a first aspect of the present invention includes:

facial image extracting means for extracting a facial image, which is an image of a facial region of a viewer, from an image of the viewer captured while the viewer views an advertising image displayed on a display device;

feature value calculating means for calculating a feature value representing a feature of the appearance of the viewer by analyzing the extracted facial image;

content image storing means for storing a plurality of content images having key information;

content image extracting means for comparing the calculated feature value of the viewer with the stored key information in order to extract a content image having key information that corresponds to the feature value of the viewer from the content image storing means; and

content image displaying means for displaying the extracted content image on the display device.

An electronic advertisement method according to a second aspect of the present invention is executed by an electronic advertisement apparatus that includes content image storing means for storing a plurality of content images having key information, and the method includes:

a facial image extraction step for extracting a facial image, which is an image of a facial region of a viewer, from an image of the viewer captured while the viewer views an advertising image displayed on a display device;

a feature value calculation step for calculating a feature value representing a feature of the appearance of the viewer by analyzing the extracted facial image;

a content image extraction step for comparing the calculated feature value of the viewer with the stored key information in order to extract a content image having key information that corresponds to the feature value of the viewer from the content image storing means; and

a content image display step for displaying the extracted content image on the display device.

A recording medium according to a third aspect of the present invention stores a program that causes a computer including content image storing means for storing a plurality of content images having key information to function as:

facial image extracting means for extracting a facial image, which is an image of a facial region of a viewer, from an image of the viewer captured while the viewer views an advertising image displayed on a display device;

feature value calculating means for calculating a feature value representing a feature of the appearance of the viewer by analyzing the extracted facial image;

content image extracting means for comparing the calculated feature value of the viewer with the stored key information in order to extract a content image having key information that corresponds to the feature value of the viewer from the content image storing means; and

content image displaying means for displaying the extracted content image on the display device.

### Advantageous Effect of the Invention

According to the present invention, a content image corresponding to the appearance of the viewer viewing the electronic advertisement apparatus is displayed on the display device, and therefore the interest of the viewer can be aroused. As a result, the advertising effectiveness of the electronic advertisement apparatus is improved.

### BRIEF DESCRIPTION OF DRAWINGS

FIG. 1 is an external view of an electronic advertisement apparatus according to an embodiment of the present invention;

FIG. 2 is a schematic diagram of the electronic advertisement apparatus according to this embodiment of the present invention;

FIG. 3 is a constitutional diagram of feature information;

FIG. 4 is a constitutional diagram of a content image;

FIG. 5 is a constitutional diagram of a server device;

FIG. 6 is a constitutional diagram of distribution schedule information;

FIG. 7 is a schematic flowchart of a main program;

FIG. 8 is a schematic flowchart of an interrupt program;

FIG. 9 is an example of an image displayed on a display device; and

FIG. 10 is an example of an image displayed on the display device.

### BEST MODE FOR CARRYING OUT THE INVENTION

An embodiment of the present invention will be described below.

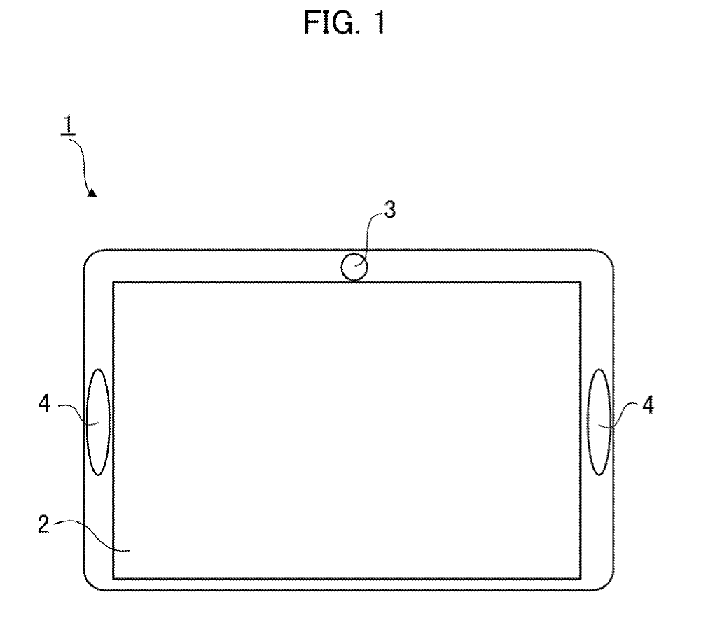

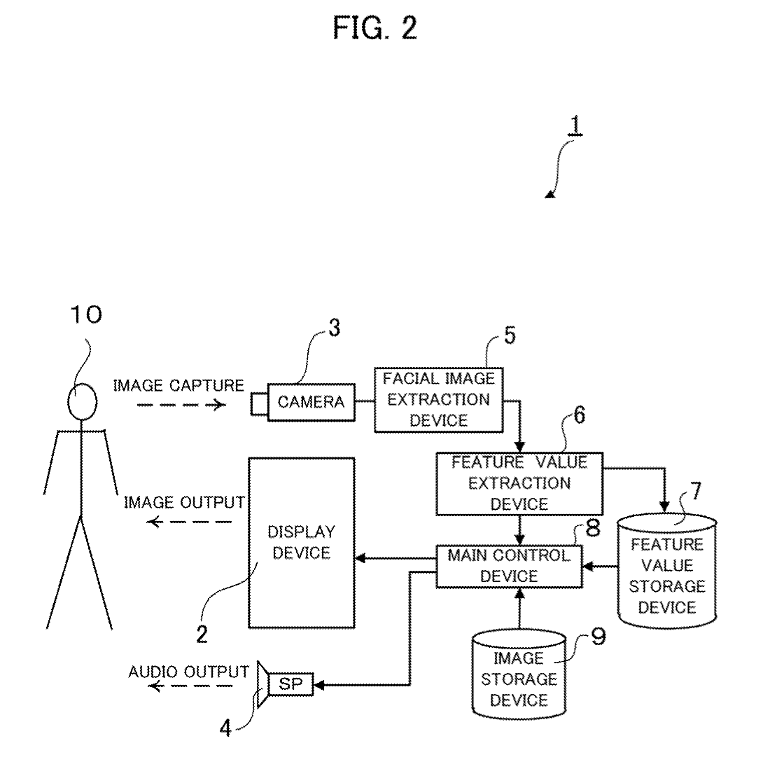

FIG. 1 is an external view of an electronic advertisement apparatus 1 according to an embodiment of the present invention, and FIG. 2 is a schematic diagram of the electronic advertisement apparatus 1.

The electronic advertisement apparatus 1 is disposed in a customer attracting facility visited by a large number of unspecified people, such as a theater, a cinema, or a large store, for example, in order to present advertising messages to the people visiting the customer attracting facility by displaying advertising video (moving images or still images) and, if necessary, outputting audio. As shown in FIGS. 1 and 2, the electronic advertisement apparatus 1 includes a display device 2, a camera 3, a speaker 4, a facial image extraction device 5, a feature value extraction device 6, a feature value storage device 7, a main control device 8, and an image storage device 9. Note that the advertising video used here is not limited to images and so on that directly encourage purchase by presenting products or the like, and is a wide ranging concept including introductions to so-called promotional events and image advertisements for propagating a brand image.

The display device 2 is a device that presents advertising video read from the image storage device 9 to a passerby 10. There are no particular limitations on the form of the display device 2, and an appropriate selection may be made from well known display devices such as a liquid crystal display device, for example. The camera 3 is a device that captures an image of the passerby 10. There are no particular limitations on the form of the camera 3, and an appropriate selection may be made from well known image pickup devices such as a CCD camera, for example. The speaker 4 is a device that outputs audio in alignment with the images displayed on the display device 2.

Further, the facial image extraction device 5 is a device that extracts an image (a facial image) of a facial region of the passerby 10 by processing the image captured by the camera 3, and determines whether or not the facial image satisfies predetermined requirements (described below).

The feature value extraction device 6 is a device that extracts a feature value indicating a feature of the facial region of the passerby 10 from the image of the facial region. Note that specific means for extracting the feature value from the facial region image may be selected appropriately from well known means such as that disclosed in Unexamined Japanese Patent Application KOKAI Publication No. 2004-139596 and so on, for example.

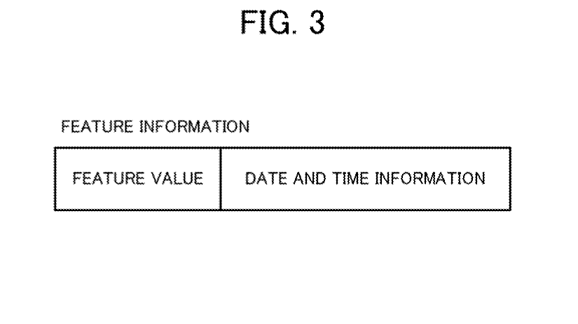

The feature value storage device 7 is a device that records the feature value (feature data) of the facial region image, extracted by the feature value extraction device 6, together with a time at which the image was obtained (captured). FIG. 3 shows a constitution of feature information stored in the feature value storage device 7. As shown in FIG. 3, the feature information is constituted by the feature value and information indicating the date and time at which the image relating to the feature value was captured.

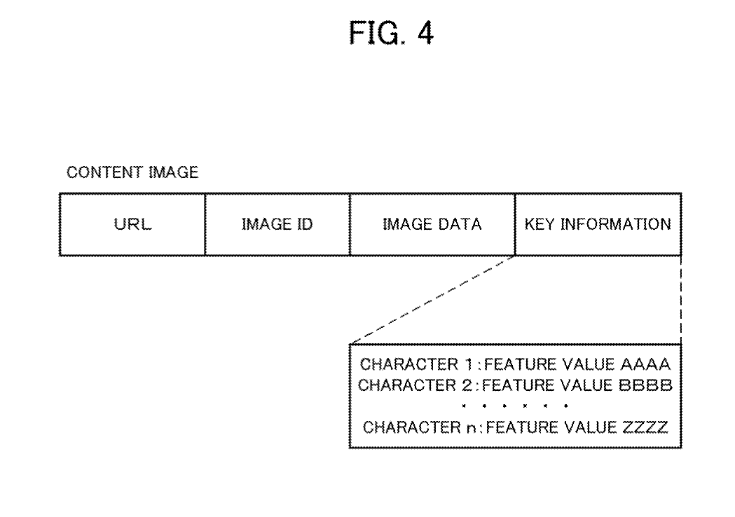

The image storage device 9 is a device that stores various content images together with key information (key data). FIG. 4 shows a constitution of a content image stored in the image storage device 9. As shown in FIG. 4, the content image is constituted by a URL, an image ID, image data, and the key information. Note that the key information will be described below.

The main control device 8 is a computer that controls the entire electronic advertisement apparatus 1 and operates in accordance with a program installed in advance. The main control device 8 compares the feature value input from the feature value extraction device 6 with a feature value recorded in the feature value storage device 7 to determine whether or not the person whose image was captured by the camera 3 is identical to a person whose image was captured within a predetermined period in the past. After determining that the people are not identical, the main control device 8 selects (extracts) a content image having key information that corresponds to the feature value of the person from the image storage device 9 and outputs the selected content image to the display device 2.

The main control device 8 is installed with a main program and an interrupt program. The main program is executed constantly while the electronic advertisement apparatus 1 is operative, and the interrupt program is executed when the camera 3 captures an image of the passerby 10 during execution of the main program.

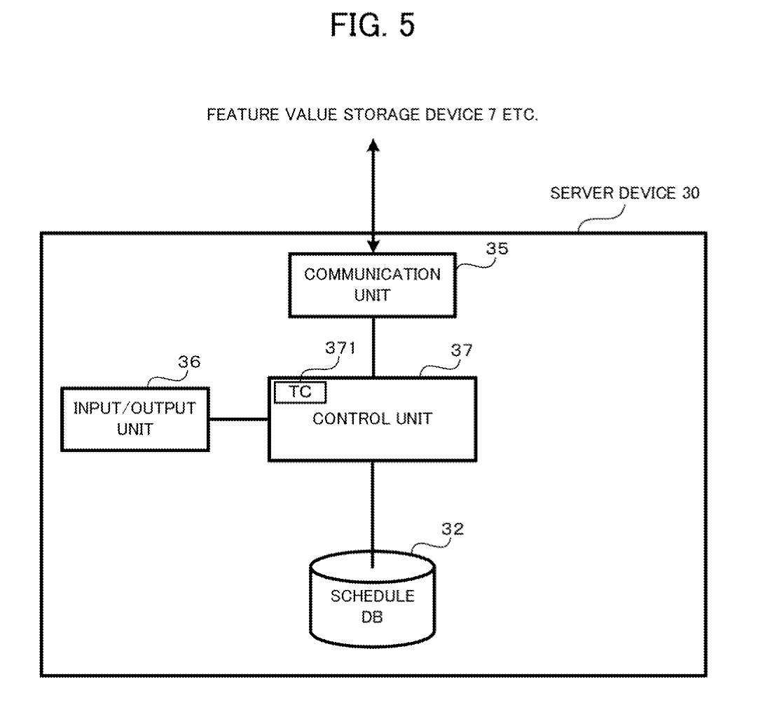

The facial image extraction device 5, feature value extraction device 6, and main control device 8 are realized physically as functions of a server device 30 having a constitution shown in FIG. 5, for example. In this example, the server device 30 is constituted by a schedule database (DB) 32, a communication unit 35, an input/output unit 36, and a control unit 37.

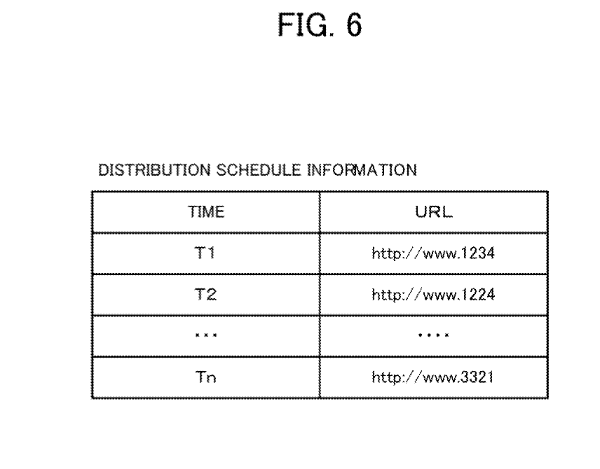

The schedule DB 32 stores an advertisement distribution (display) schedule for each electronic advertisement apparatus 1. As shown in FIG. 6, for example, the distribution schedule includes a time (hours, minutes, and seconds) and an address (a URL (Uniform Resource Locator)) of a storage position of an advertising image (a moving image including audio, for example) to be displayed.

The communication unit 35 communicates with the feature value storage device 7 and so on via a communication network.

The input/output unit 36 is constituted by a keyboard, a mouse, a display device, and so on, and is used to input various instructions and data into the control unit 37 and display data and the like output from the control unit 37.

The control unit 37 is constituted by a processor or the like, and includes a timer TC 371. The control unit 37 operates in accordance with a control program to execute the main program (to be referred to hereafter as a “main PGM” where appropriate) and the interrupt program (to be referred to hereafter as an “interrupt PGM” where appropriate), as will be described below.

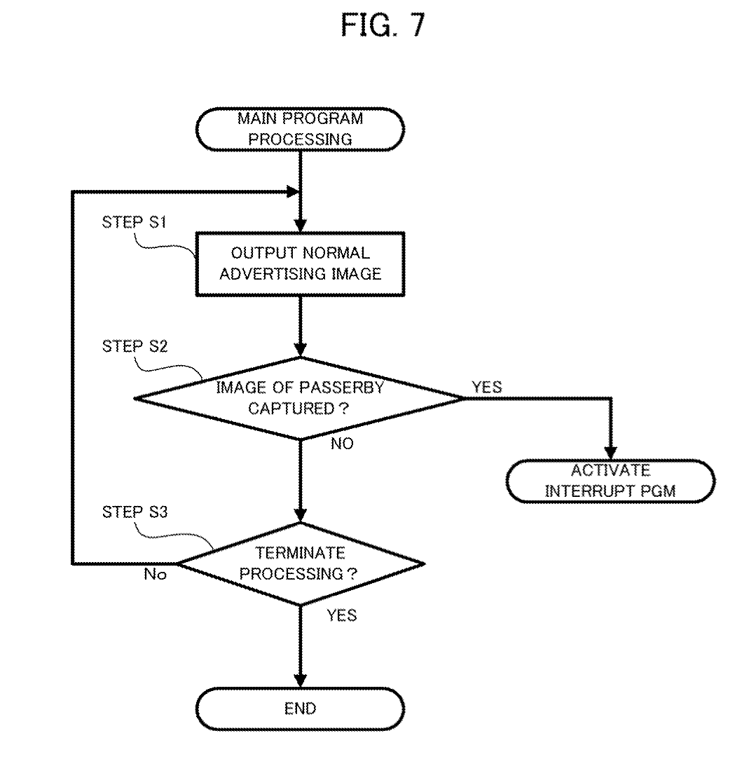

Under normal conditions, the control unit 37 executes main program processing shown in FIG. 7 repeatedly. For example, the control unit 37 reads a normal image from the image storage device 9 in accordance with a measured time of the timer TC and the schedule and displays the read image on the display device 2 (step S1). For example, a normal advertising image (a moving image showing a trailer of a movie, for example) is output to the display device 2 repeatedly.

Next, the control unit 37 downloads a frame image output by the camera 3 and determines the presence of a passerby (step S2). When the control unit 37 detects a passerby, or in other words when the camera 3 captures a form of the passerby 10 (step S2: YES), the control unit 37 executes interrupt program processing. Further, when a switch, not shown in the drawings, is operated to request termination processing (step S3: YES), the control unit 37 terminates the main program processing.

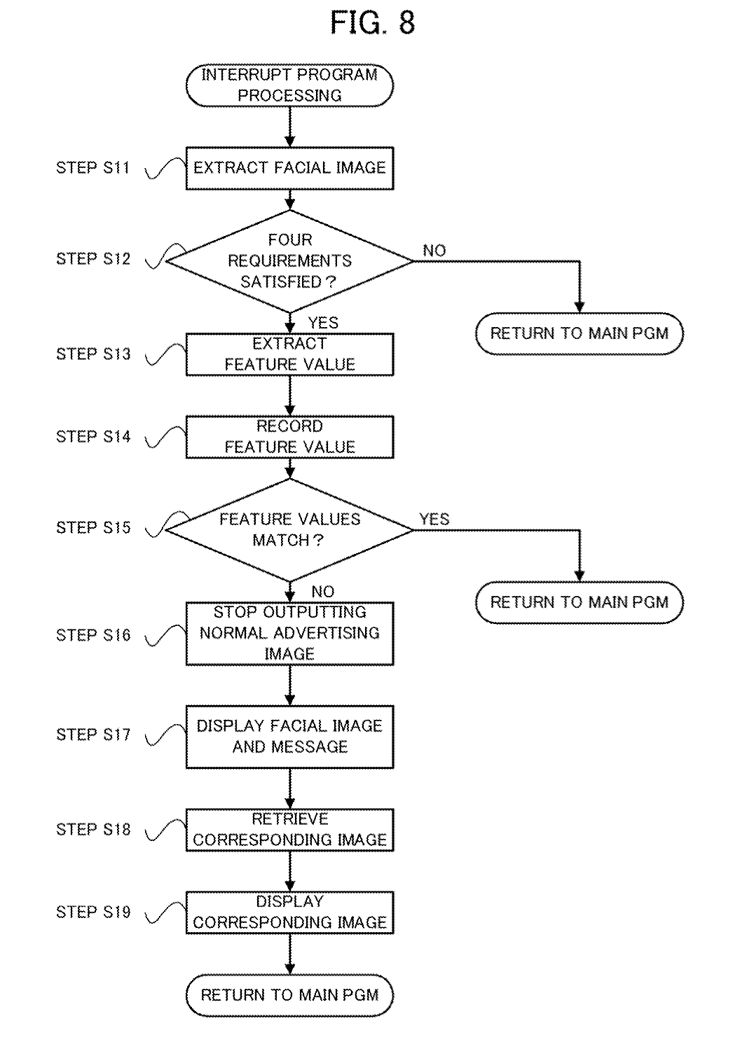

Having detected a passerby, the control unit 37 executes interrupt program processing shown in FIG. 8. First, the control unit 37 extracts an image of the facial region of the passerby 10 by having the facial image extraction device 5 process the image captured by the camera 3 (step S11). Next, the control unit 37 determines (examines) whether or not the following four requirements are satisfied (step S12).

(1) The passerby 10 is near the center of a field of view of the camera 3.

(2) The passerby 10 is within a predetermined range in the vicinity of the camera 3.

(3) The face of the passerby 10 directly opposes the display device 2.

(4) A predetermined time has elapsed since the image of the passerby 10 was captured by the camera 3 (the passerby 10 has remained within the range of the field of view of the camera 3 for longer than the predetermined time).

To test these requirements, first, the control unit 37 specifies a facial image included within the captured image through pattern matching or the like.

Next, to determine whether or not condition (1) is satisfied, a determination is made as to whether or not the facial image is positioned within a circle having a predetermined radius r or a predetermined rectangle from the center of a frame image. When the facial image is positioned within the circle or rectangle, it is determined that the condition is satisfied.

Next, to determine whether or not condition (2) is satisfied, a determination is made as to whether or not a size of the face in the frame image is equal to or greater than a reference value. When the size of the face is equal to or greater than the reference value, it may be determined that the passerby 10 is within the predetermined range in the vicinity of the camera 3.

Next, to determine whether or not condition (3) is satisfied, a determination is made as to whether or not a set of two black points (estimated to be images of eyes) at a fixed distance (corresponding to 10 to 18 cm) can be extracted from the facial image. When a set of two black points (estimated to be images of eyes) at a fixed distance (corresponding to 10 to 18 cm) can be extracted from the facial image, it may be determined that both eyes are oriented in the direction of the camera 3, and therefore that the passerby 10 directly opposes the display device 2.

Next, to determine whether or not condition (4) is satisfied, a feature value of the face is determined from the facial image. Furthermore, the image output by the camera 3 is checked again following the elapse of a predetermined time to determine whether or not conditions (1) to (3) remain satisfied and the feature value is identical.

Note that the determinations relating to the four requirements described above are made to ensure that video such as that to be described below is presented only to people who exhibit a keen interest in the advertising image presented by the electronic advertisement apparatus 1. A person who stands directly in front of the display device 2 and close to the display device 2 with his/her face oriented directly toward the display device 2 and remains in that position for longer than the predetermined time is likely to have a keen interest in the advertising image presented by the electronic advertisement apparatus 1, and therefore, by presenting special video to such a person, a large improvement in advertising effectiveness can be expected. On the other hand, typical video is presented to a person who does not exhibit interest in the advertising image presented by the electronic advertisement apparatus 1.

After determining that the four requirements described above are not satisfied (step S12: NO), the control unit 37 terminates the interrupt program processing and returns to the main program processing (processing for executing the main program).

After determining that the four requirements described above are satisfied (step S12: YES), the'control unit 37 (the facial image extraction device 5) extracts a feature value from the facial region image of the passerby 10 (step S13). Note that the feature value is a parameter expressing a feature of the appearance of a person as a numerical value, which is useful for verifying and identifying the passerby 10. For example, a feature such as a hairstyle, a position or a shape of the eyes, pose, mouth, ears, and eyebrows, a positional relationship between these elements, a facial contour, and a skin color is converted into a numerical value and set as the feature value.

After extracting the feature value from the facial image of the passerby 10, the control unit 37 (the facial image extraction device 5) records the feature value in the feature value storage device 7 together with the time at which the facial image was captured (step S14).

Next, the control unit 37 determines (verifies) whether or not the features value matches a feature value recorded in the feature value storage device 7 in relation to a person whose image was captured by the camera 3 in the past (step S15). Having determined that the feature value is substantially identical to the feature value of a person whose image was captured within a predetermined period in the past, or in other words that a facial image of an identical person was captured within the predetermined period (step S15: YES), the control unit 37 terminates the interrupt program processing and returns to the main program processing.

Having determined that the feature value does not match any of the feature values extracted within the predetermined period in the past, or in other words that the passerby 10 has been photographed for the first time within the range of the predetermined period (step S15: NO), the control unit 37 stops outputting the normal advertising image (step S16).

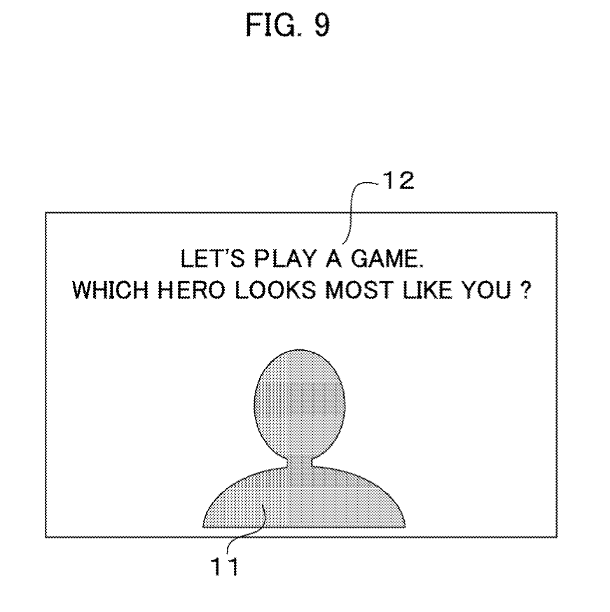

Next, the main control device 8 (the control unit 37) displays an image (facial image) 11 of the passerby 10 on the display device 2 together with a predetermined message 12 (step S17). FIG. 9 shows the image displayed on the display device 2. The image shown in FIG. 9 is an image for arousing the interest of the passerby 10 by indicating to the passerby 10 him/herself that he/she has been recognized by the electronic advertisement apparatus 1.

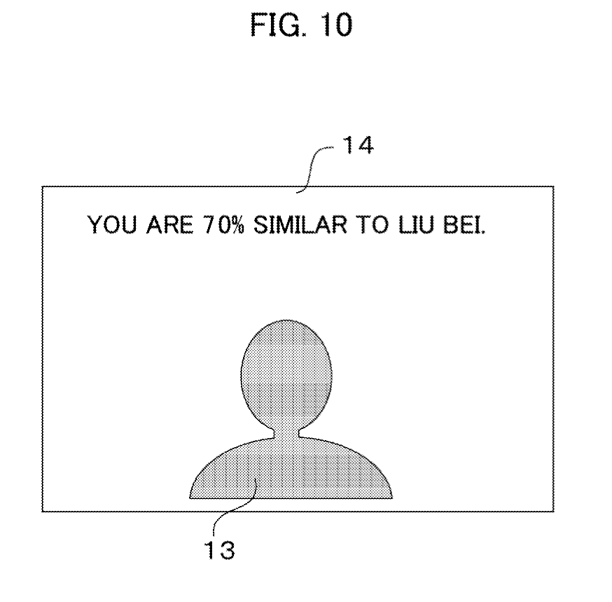

Next, the main control device 8 (the control unit 37) searches the image storage device 9 (step S18), extracts a content image including key information that corresponds to the feature value of the passerby 10, and displays the extracted content image on the display device 2 (step S19). In this embodiment, an advertising message relating to a movie is employed, and therefore a feature value relating to the appearance of a character (a performer, a cartoon character, and so on) who appears in the movie is attached to the content image as the key information. Hence, the main control device 8 (the control unit 37) calculates a similarity between the feature value of the passerby 10 and the feature values of respective characters, and displays a content image illustrating the character having the greatest similarity (i.e. the character who most closely resembles the passerby 10), for example a character image (facial image) 13 shown in FIG. 10, on the display device 2 together with a predetermined message 14. Note that in FIG. 10, “70% similar” is displayed, but this need not be a mathematically accurate numerical value. The electronic advertisement apparatus 1 is ultimately an apparatus for displaying advertisements, and therefore an additional operation may be performed to increase the value of the “similarity” in order to make the passerby 10 feel happy and encourage him/her to buy a product or visit a cinema.

To further arouse the interest of the passerby 10 and further enhance the advertising effectiveness, an episode pertaining to the character or the like may be introduced after displaying an image such as that shown in FIG. 10. Furthermore, in the case of a movie advertisement, the passerby 10 may be encouraged to go to the cinema by displaying the nearest show times. Alternatively, a message that allows the passerby 10 to earn some kind of bonus, for example a password for receiving a discount or the like, may be displayed.

Moreover, the content image displayed on the display device 2 is not limited to a “character resembling the passerby 10”. For example, the sex, age, and so on of the passerby 10 may be estimated from the feature value of the passerby 10, and an advertising image for a product or a service corresponding thereto may be displayed on the display device 2.

After completing display of the content image in the manner described above, the main control device 8 (the control unit 37) terminates the interrupt program processing and returns to the main program processing in order to start outputting the normal advertising image again.

Note that the present invention is not limited to the embodiment described above, and may be subjected to various amendments and applications.

In this embodiment, the facial image extraction device 5, feature value extraction device 6, feature value storage device 7, main control device 8, and image storage device 9 are illustrated as functions of the server device 30. However, these devices may be executed using dedicated hardware.

Further, the respective data constitutions and processing procedures of the above devices may be modified appropriately. For example, in the constitution shown in FIG. 3, a facial feature value (feature data) obtained from the facial image or the like may be used instead of the facial image (or in addition to the facial image). Further, in the step S15 in FIG. 8, rather than waiting for a fixed time period using the timer TC 371, a determination may be made as to whether or not an identical facial image has been obtained by temporarily terminating the processing and then repeating the processing for a fixed time period.

Furthermore, a program describing the processing performed by these devices may be recorded on a recording medium and distributed or the like.

The present application is based on Japanese Patent Application No. 2008-288284, with a filing date of Nov. 10, 2008, the specification, claims, and drawings thereof being incorporated in their entirety into the present specification by reference.

### INDUSTRIAL APPLICABILITY

The present invention may be applied to an electronic advertisement apparatus disposed in a customer attracting facility or the like.

### DESCRIPTION OF REFERENCE NUMERALS

1 electronic advertisement apparatus
2 display device
3 camera
4 speaker
5 facial image extraction device
6 feature value extraction device
7 feature value storage device
8 main control device
9 image storage device
10 passerby
11 image
12 message
13 image
14 message

1. An electronic advertisement apparatus characterized by comprising:
a facial image extracting unit for extracting a facial image, which is an image of a facial region of a viewer, from an image of the viewer captured while the viewer views an advertising image displayed on a display device;
a feature value calculating unit for calculating a feature value representing a feature of the appearance of the viewer by analyzing the extracted facial image;
a content image storing unit for storing a plurality of content images having key information;
a content image extracting unit for comparing the calculated feature value of the viewer with the stored key information in order to extract a content image having key information that corresponds to the feature value of the viewer from the content image storing unit; and
a content image displaying unit for displaying the extracted content image on the display device.

2. The electronic advertisement apparatus according to claim 1, characterized in that the key information is constituted by character feature values expressing features of the appearance of characters respectively represented by the content images, and
the content image extracting unit compares the calculated feature value of the viewer with the stored character feature values in order to calculate a similarity therebetween, and extracts a content image having a character feature value that is most similar to the feature value of the viewer from the content image storing unit.

3. The electronic advertisement apparatus according to claim 1, characterized in that the facial image extracting unit also measures a viewing time during which the viewer views the advertising image, and
the content image displaying unit displays the extracted content image on the display device when the measured viewing time exceeds a predetermined time.

4. The electronic advertisement apparatus according to claim 1, characterized in that the facial image extracting unit also measures an orientation of a face of the viewer relative to the display device, and
the content image displaying unit displays the extracted content image on the display device when the measured orientation of the face of the viewer is within a predetermined range.

5. The electronic advertisement apparatus according to claim 1, characterized in that the facial image extracting unit also measures a distance between the display device and a face of the viewer, and
the feature value calculating unit calculates the feature value of the viewer when the measured distance is smaller than a predetermined value.

6. The electronic advertisement apparatus according to claim 1, characterized in that the facial image extracting unit also measures a position of a face of the viewer within the captured image, an orientation of the face of the viewer relative to the display device, a distance between the display device and the face of the viewer, and a time during which the viewer is included within the captured image, and
the content image displaying unit displays the extracted content image on the display device only when the position of the face of the viewer within the captured image is included in a predetermined region, the face of the viewer directly opposes the display device, the distance between the display device and the face of the viewer is smaller than a predetermined value, and the time during which the viewer is included within the captured image exceeds a predetermined time.

7. The electronic advertisement apparatus according to claim 1, characterized by further comprising a feature value storing unit for storing the feature value of the viewer calculated by the feature value calculating unit together with a time at which the feature value was obtained,
wherein the content image displaying unit compares the calculated feature value of the viewer with feature values stored in the feature value storing unit, and displays the extracted content image on the display device when the calculated feature value of the viewer is not identical to a feature value obtained within a predetermined period.

8. An electronic advertisement method executed by an electronic advertisement apparatus that includes a content image storing unit for storing a plurality of content images having key information, the method characterized by comprising:
a facial image extraction step for extracting a facial image, which is an image of a facial region of a viewer, from an image of the viewer captured while the viewer views an advertising image displayed on a display device;
a feature value calculation step for calculating a feature value representing a feature of the appearance of the viewer by analyzing the extracted facial image;
a content image extraction step for comparing the calculated feature value of the viewer with the stored key information in order to extract a content image having key information that corresponds to the feature value of the viewer from the content image storing unit; and
a content image display step for displaying the extracted content image on the display device.

9. A recording medium characterized by storing a program that causes a computer including a content image storing unit for storing a plurality of content images having key information to function as:
a facial image extracting unit for extracting a facial image, which is an image of a facial region of a viewer, from an image of the viewer captured while the viewer views an advertising image displayed on a display device;
a feature value calculating unit for calculating a feature value representing a feature of the appearance of the viewer by analyzing the extracted facial image;
a content image extracting unit for comparing the calculated feature value of the viewer with the stored key information in order to extract a content image having key information that corresponds to the feature value of the viewer from the content image storing unit; and
a content image displaying unit for displaying the extracted content image on the display device.
